(19) United States
(12) Patent Application Publication
(10) Pub. No.: US 2011/0069348 A1
(43) Pub. Date: Mar. 24, 2011

(54) IMAGE FORMING APPARATUS AND IMAGE FORMING METHOD

(75) Inventor: Michio Yoshitake, Onga-cho (JP)

(73) Assignee: SEIKO EPSON CORPORATION, Shinjuku-ku (JP)

(21) Appl. No.: 12/885,282

(22) Filed: Sep. 17, 2010

(30) Foreign Application Priority Data
Sep. 18, 2009 (JP) 2009-216442

(51) Int. Cl. G06F 3/12

(52) U.S. Cl. 358/1.15

(57) ABSTRACT

An image forming apparatus includes an image formation section that receives print data and forms an image corresponding to the print data on a recording material, a display section that receives display data and displays a screen image corresponding to the display data, a storage section that stores the print data and the display data, and a control device that executes a print data process for outputting the print data from the storage section to the image formation section, and a display data process for creating the display data to write into the storage section and outputting the display data from the storage section to the display section, and the control device performs scheduling for the print data process and the display data process based on the print data before output of the print data corresponding to an image of one page is started.

### BACKGROUND

1. Technical Field

The present invention relates to an image forming apparatus that includes an image forming unit for forming an image on a recording material and a display unit for displaying a screen image and an image forming method.

2. Related Art

There is an image forming apparatus that is provided with a display unit for informing a user of information such as operation methods, progress states of operation, and the like in image forming apparatuses that form images on recording materials such as paper and the like. For example, the image forming apparatus disclosed in JP-A-2008-186112 (for example, FIGS. 2 and 3) causes the liquid crystal display mounted on the apparatus to display a help menu, and enables users to operate the apparatus with no difficulty and little effort.

In order to realize such a function, the image forming apparatus in the related art is provided with a dedicated device such as a controller IC that controls a liquid crystal display, memory that stores data for display, or the like.

With apparatuses of this kind, there is a demand for further decreases in size and cost. For this reason, there is a desire to incorporate a System On a Chip (SOC) that controls an entire apparatus therein for the control of a display unit, which has been executed by a dedicated device in the related art. In this case, the SOC is required to display a given screen image in the display unit while performing an image forming operation that forms images on a recording material. At the same time, the screen images to be displayed have come to be complex as such apparatuses are multi-functional.

In particular, the largeness of the size and high image quality of a screen on a display unit have been improved in recent years, and there has been a demand to use such a screen not only as a simple operation guide but also for other purposes, such as regularly switching and displaying images, for example, photos, in other words, displaying a slide show. If a process for such display is included therein, there is a concern that the process may affect the image forming operation, and parallel execution of video display and image forming operation in a single SOC becomes difficult. Specifically, when print data for the image forming operation and display data for video display are stored together in a storing unit, there may be a problem in that two respective processes involving the different data are in competition for access to the storing unit.

### SUMMARY

An advantage of some aspects of the invention is that a technology is to be provided which solves the above problems and achieves a small size and low cost for an image forming apparatus that includes an image forming unit for forming an image on a recording material and an image forming method, and enables the display of various screen images without having any influence on the image forming operation.

According to an aspect of the invention, an image forming apparatus includes an image formation section that receives print data and forms an image corresponding to the print data on a recording material, a display section that receives display data and displays a screen image corresponding to the display data, a storage section that stores the print data and the display data, and a control device that executes a print data process for outputting the print data from the storage section to the image formation section, and a display data process for creating the display data to write into the storage section and outputting the display data from the storage section to the display section. In addition, the control device performs scheduling for the print data process and the display data process based on the print data before output of the print data corresponding to an image of one page is started.

In addition, according to another aspect of the invention, an image formation method includes executing a print data process in which print data stored in a storage section are given to an image formation section and an image corresponding to the print data is formed on a recording material, and a display data process in which display data stored in the storage section are given to a display section and a screen image corresponding to the display data is displayed, and scheduling the print data process and the display data process based on the print data before the output of the print data corresponding to an image of one page is started.

From the print data of one-page image, the data amount to be given to the image formation section and the timing for printing the page can be estimated. Therefore, the access amount to the storage section also can be estimated in advance. In the invention of this kind, since the print data process and the display data process are subjected to scheduling in advance based on the print data, competition for access to the storage section can be avoided and the print data process and the display data process can be performed in parallel. For that reason, in the invention, various screen images can be displayed without having an influence on the image forming operation, and therefore, since it is not necessary to increase the size of apparatus structure, a small size and low cost of the apparatus can be achieved.

In the invention, for example, each piece of block data may be output as block data, which are obtained by splitting the print data corresponding to the image of one page into a plurality of pieces, to the image formation section in order, and the scheduling may be performed according to a predicted result of time required for outputting each piece of the block data. By doing this, even when data amount of the block data is not constant, competition for access to the storage section between the print data process and the display data process can assuredly be avoided.

In this case, each piece of the block data may be output in a predetermined cycle, and the display data process may be executed in a period different from a period for outputting the block data in one cycle. The apparatus of this kind mainly aims at image formation onto a recording material, and it is preferable to assign a spare time for a display data process after securing a processing time for a print data process first. In light of this point, the display data process may be executed in a spare time when block data are output on a regular basis.

In addition, as such a display data process, for example, a slide show operation may be performed in which a plurality of still images are switched and displayed in the display section in order. Slide show operation in the invention, still images are displayed in order in the display section during image forming operation, and the display section can function as a so-called photo frame, thereby giving the apparatus increased multifunctionality.

In this case, when the still images to be displayed in the display section are switched from a first still image to a second still image, display data for switching, which are created based on image data corresponding at least to one of the first still image and the second still image, may be output to the display section. Accordingly, a screen image formed by processing still images to be displayed can be displayed in the display section, and expression with high visual effect can be attained.

In addition, in the apparatus of this kind, the display data may be output to the display section at a predetermined frame rate on a regular basis, and moreover, the frame rate may be variable. When display data are transmitted from the storage section to the display section at a fixed frame rate, access to the storage section is made at a fixed time in order to perform the process. If access frequency is reduced by making the frame rate variable, distribution of processing capability for the print data process and the display data process can be optimized.

In addition, the image formation section includes a transporting mechanism that performs pitch-feeding of the recording material in a first direction and heads for printing that execute scanning movement in a second direction intersecting the first direction and supply a colorant on the recording material according to the print data, and may form an image on the recording material by alternately executing the pitch-feeding by the transporting mechanism and the scanning by the heads for printing.

When the image formation section has the composition as above, supply of print data from the control device to the heads for printing is necessary when scanning by the head for printing is performed, and the supply is not necessary when pitch-feeding of a recording material is performed. Therefore, by performing scheduling so as to execute the display data process in spare time of the print data transmission, a sophisticatedly processed screen image can be displayed without having any influence on image formation on the recording material.

### BRIEF DESCRIPTION OF THE DRAWINGS

The invention will be described with reference to the accompanying drawings, wherein like numbers reference like elements.

FIG. 1 is a perspective view showing an embodiment of a photo printer to which the invention is applied.

FIG. 2 is a diagram illustrating an overview of the internal composition of the photo-printer.

FIG. 3 is a block diagram illustrating the electronic composition of the photo printer of FIG. 1.

FIG. 4 is a block diagram illustrating the composition of an LCD controller.

FIG. 5 is a block diagram illustrating the composition of a synchronization signal generating unit.

FIG. 6 is a diagram illustrating the structure of an image formed by a print mechanism.

FIG. 7 is a diagram illustrating an example of a schedule table created as a result of scheduling.

FIG. 8 is a timing chart illustrating processes based on the scheduling of FIG. 7.

FIG. 9 is a flowchart showing a schedule table creating process of the embodiment.

FIG. 10 is a flowchart showing a display process.

FIG. 11 is a flowchart showing a switching process of the embodiment.

FIG. 12 is a flowchart showing a frame rate renewal process.

### DESCRIPTION OF EXEMPLARY EMBODIMENTS

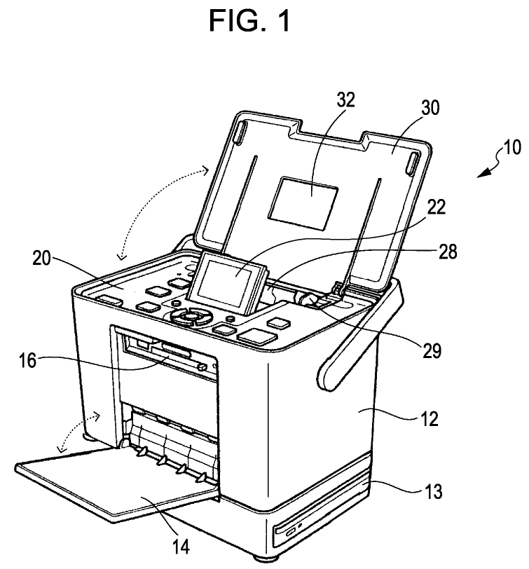

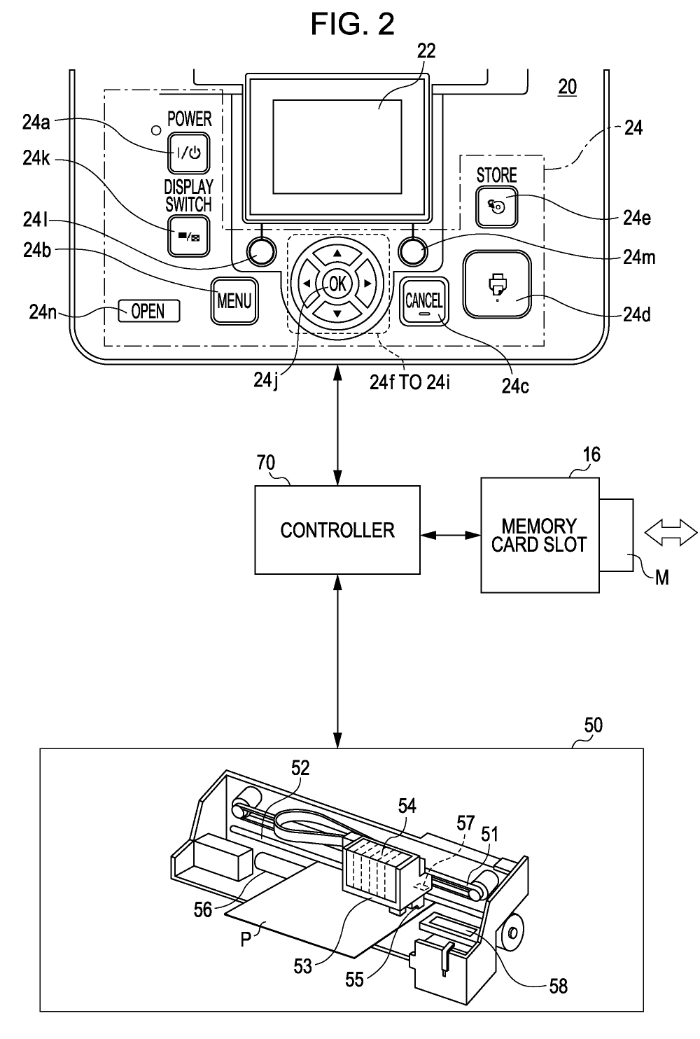

FIG. 1 is a perspective view showing an embodiment of a photo printer to which the invention is applied. In addition, FIG. 2 is a diagram illustrating an overview of the internal composition of the photo-printer. The photo printer 10 has a printer main body 12 that is built with a print mechanism 50, and printing is performed onto a sheet P according to an operation command from a controller 70 that controls the print mechanism 50. Furthermore, the sheet P subjected to the printing is discharged on the front of the printer main body 12.

A front door 14 is attached to the front of the printer main body 12 so as to be opened and closed freely. The front door 14 is a cover for opening and closing the front of the printer main body 12. In addition, the front door functions as a discharge tray to receive a sheet P discharged from the print mechanism 50 in an open state. In addition, various types of memory card slots 16 provided in the front of the printer main body 12 are in a state where a user can use them. In other words, in that state, a user can insert a memory card M storing image files to be printed into one of the memory card slots 16. Furthermore, in this embodiment, other discs can be used such as a Compact Disc Recordable (CD-R), a video Digital Versatile Disc (DVD), and the like as a storing medium, in addition to memory cards. In other words, an optical disc drive 13 is provided in a base portion of the printer main body 12.

In addition, an operation panel 20 is provided on the top of the printer main body 12, and a cover 30 is attached to one side of a recess on the top of the printer main body 12 so as to be opened and closed freely. The cover 30 is a resin plate molded in a size enough to cover the top of the printer main body 12, and exposes the surface of the operation panel 20 to the outside in the open state. On the other hand, the cover 30 covers the entire operation panel 20 in the closed state.

The operation panel 20 is provided with a display unit 22 that is composed of, for example, a Liquid Crystal Display (LCD) displaying characters, figures, symbols, and the like and a button group 24 arranged around the display unit 22. As shown in FIG. 2, the button group 24 includes a power button 24a for turning power on and off, a menu button 24b for calling up a main menu screen, a cancel button 24c for cancelling operation or stopping printing onto a sheet P during the execution, a print button 24d for instructing print execution onto a sheet P, a storing button 24e for storing edited images or the like in the memory card M that is inserted in the memory card slot 16, up, down, right, and left arrow buttons 24f to 24i to be manipulated for selecting a desired option from a plurality of options displayed in the display unit 22 or moving a cursor, an OK button 24j which is arranged in the center of the up, down, right, and left arrow buttons 24f to 24i and used for instructing a decision of an option selected by each of the arrow buttons 24f to 24i, a display switch button 24k for switching screen display in the display unit 22, a left guide selection button 24l for selecting the left guide displayed in the display unit 22, a right guide selection button 24m for selecting the right guide displayed in the display unit 22, a paper delivery tray open button 24n for opening the front door 14 functioning as a paper delivery tray.

In addition, a window 32 is provided in the same size as the display unit 22 on the cover 30 so as to check displayed content in the display unit 22. In other words, a user can check displayed information of the display unit 22 through the window 32 when the cover 30 is in the closed state. On the other hand, when the cover 30 is in the open state, the display unit 22 can be adjusted to a preferred angle as shown in FIG. 1.

When the cover 30 is in the open state as such, the cover 30 inclines toward the operation panel 20 to be held in a backward oblique state so that the cover functions as a tray for supplying a sheet P to the print mechanism 50. In addition, a sheet feeding port 28 of the print mechanism 50 is provided in the recess of the operation panel 20, and a pair of sheet guides 29 is provided which is manipulated in right-left direction in a sliding manner so as to fit the width of the guides into the width of a sheet.

In addition, a sheet P is sent into the print mechanism 50 through the sheet feeding port 28 to execute printing. As shown in FIG. 2, in the print mechanism 50, a carriage 53 is driven by a timing belt 51 bridged over in a right-left direction in a loop shape to reciprocate right and left along a guide 52. The carriage 53 is provided with a sensor 57 which detects the right-left edge and upper-lower edge of a sheet P. In other words, the sensor 57 can recognize the width of a sheet by detecting the right-left edge of the sheet when the carriage 53 performs scanning in the right-left direction for the sheet set in the sheet feeding port 28 before printing, and recognize the length of the sheet by detecting the tailing edge of the sheet during printing.

In addition, the carriage 53 is mounted with ink cartridges 54 that respectively contain ink of each color including cyan, magenta, yellow, black, and the like. The ink cartridges 54 are connected to print heads 55 respectively. Moreover, the print heads 55 eject ink from nozzles (not shown) to a sheet P by applying pressure to ink from the ink cartridges 54. In this embodiment, the print heads 55 employ a method of deforming piezoelectric devices and putting pressure on ink by applying voltage to the piezoelectric devices, but may employ another method in which voltage is applied to a heating resistor (for example, a heater, or the like) in order to heat ink and pressure is put on the ink by bubbles generated from the heating. The sheet P printed in that manner is sent out to the front door (paper delivery tray) 14 in the open state by a transporting roller 56. In addition, for the formation of images, a toner or a developer may be used instead of ink.

A cap 58 is provided in a position opposite to the print heads 55 when the carriage 53 shown in FIG. 2 is moved to a cap position in the rightmost side within the movement range. The cap 58 is covered by the nozzles of the print heads 55 to prevent clogging of the nozzles caused by dried ink when a printing operation is not performed for a long period of time. In addition, even when the apparatus is in the power-off state, the carriage 53 is located on the cap position, and thereby, subjecting the nozzles to capping.

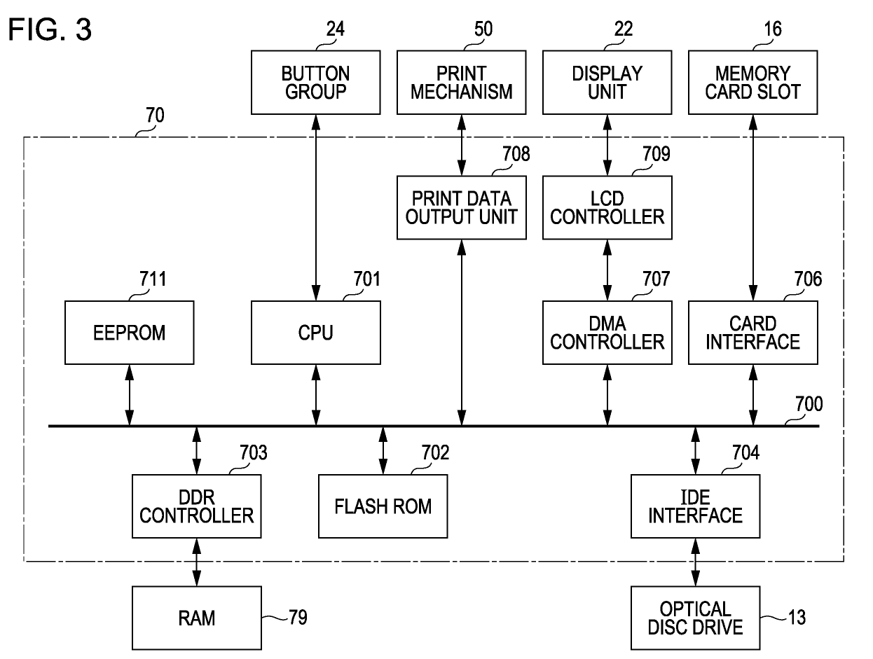

FIG. 3 is a block diagram illustrating the electronic composition of the photo printer of FIG. 1. The controller 70 is constituted by a System On a Chip (SOC) where a plurality of functioning blocks is integrated on one chip, and includes a system bus 700 as shown in FIG. 3. The system bus 700 is connected with a CPU 701, a flash ROM 702, a Double Data Rate (DDR) controller 703, an Integrated Drive Electronics (IDE) interface 704, an EEPROM 711, a card interface 706, a Direct Memory Access (DMA) controller 707, a print data output unit 708, an LCD controller 709, and the like.

The CPU 701 performs an arithmetic process for executing control of operating the print mechanism 50. The flash ROM 702 is electronically rewritable nonvolatile memory, and stores programs (firmware) necessary for controlling the CPU 701, and various data, tables or the like necessary for the control. The EEPROM 711 is electronically rewritable memory, and stores data to be kept even in a state where supply of power to the apparatus is shut off.

The DDR controller 703 is in charge of access to a high-speed RAM 79 of a DDR type, which is attached outside the controller 70 and temporarily stores data necessary for data processing and operation of the CPU 701. The card interface 706 performs communication with the memory card slots 16 and reads out image data in an external storage medium such as the memory card M inserted in one of the memory card slots 16. In addition, the card interface 706 writes image data in the memory card M in order to keep edited images or the like. The IDE interface 704 is in charge of transmission of data with the optical disc drive 13.

The CPU 701 performs image processing necessary for the image data received from the external storage medium such as the memory card M read out by the card interface 706, generates print data corresponding to the image to be printed by the print mechanism 50, and sends the data to the print data output unit 708 (print data output processing). For example, synthesized image data are prepared by synthesizing the image data read out from the memory card M and image frame data read out from the flash ROM 702, and output to the print data output unit 708. The print data output unit 708 generates a print control signal based on the image data prepared by the CPU 701, and outputs the signal to the print mechanism 50. The print mechanism 50 executes printing operation based on the print control signal and forms an image corresponding to an image file on the sheet.

In addition, the CPU 701 performs polling which is to check whether each of operation buttons composing the button group 24 has been pressed by a user or not on a regular basis, for example, in every 200 msec, and executes acceptance processing according to an operated button when the user's operation of any operation button is detected. For example, when the user presses the power button 24a in a state where power is being supplied to the apparatus, the power supply to each part of the apparatus is shut down. Furthermore, for example, when the print button 24d is pressed, the image data is given to the print data output unit 708 to generate the print control signal, and the print mechanism 50 is made to perform print operation.

Furthermore, the CPU 701 performs a process of preparing display data corresponding to video to be displayed in the display unit 22 (hereinafter, referred to as a “display process”). Screen images to be displayed in the display unit 22 include still images for informing a user of an operation method or a progressing state of a process, animations, moving images for demonstration, or the like, in addition to preview images for images formed by the print mechanism 50. The screen images other than the preview images have content that is determined in advance, and screen image data corresponding to the screen images are stored in the flash ROM 702.

The flash ROM 702 stores not only the screen image data but also information indicating that the screen image is any of a still image, an animation, and a moving image, and information relating to the frame rate that is most appropriate for displaying the screen image. The still image referred to here is a screen image of which displayed content does not change for a certain period of time if there is no change in the operation or a progressing state of a process due to the user. In addition, an animation refers to a screen image with simple motions such as flickering of part of the screen image or moving a specific character on the screen. In addition, a moving image refers to a screen image with smooth motions over the entire screen.

The CPU 701 causes the RAM 79 to store display data that are read from the flash ROM 702, for example, data processed according to necessity such as synthesis with the preview image, or the like. The display data prepared on the RAM 79 in that manner are sent to the LCD controller 709 via the DMA controller 707 on a regular basis, and the LCD controller 709 generates a video signal based on the received display data, and outputs the signal to the display unit 22. Accordingly, images corresponding to the display data are displayed in the display unit 22.

Moreover, the photo printer 10 has a so-called slide show function which is to read out images stored in a storage medium such as the memory card M or the like and display the images in the display unit 22 in order. In other words, the photo printer 10 can execute the operation (slide show operation) in which, after an image stored in a storage medium such as the memory card M inserted in one of the memory card slots 16 or an optical disc inserted in the optical disc drive 13 is read out and displayed in the display unit 22 for a certain period of time, another image read out from the storage medium is displayed in a switching manner. The slide show operation can be executed when the print mechanism 50 does not perform printing operation, and during printing operation performed by the print mechanism 50. The slide show operation will be described later.

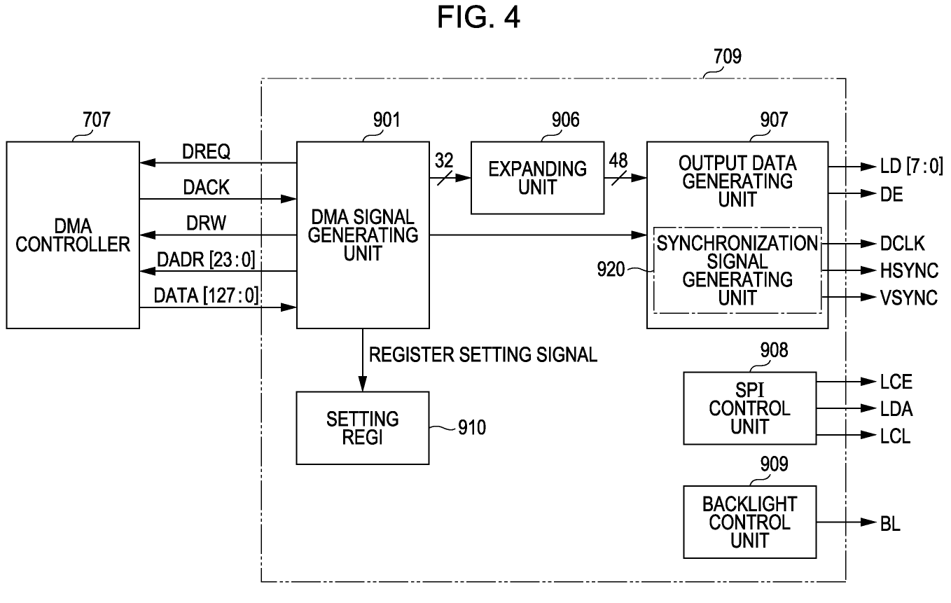

FIG. 4 is a block diagram illustrating the composition of the LCD controller. The LCD controller 709 is provided with a DMA signal generating unit 901, an expanding unit 906, an output data generating unit 907, an SPI control unit 908, a backlight control unit 909, a setting register 910, and the like.

The DMA signal generating unit 901 functions as an interface exchanging data between the DMA controller 707. Specifically, when there is no data in a data buffer provided inside, the DMA signal generating unit outputs a data request signal DREQ to the DMA controller 707. In addition, the DMA signal generating unit 901 outputs to the DMA controller 707 a direction signal DRW which defines the required direction of access to the RAM 79, that is, whether the access is for data writing or data reading, and an address signal DADR which indicates the address of the RAM 79 to be accessed. According to the output, the DMA controller 707 gets access to the designated address of the RAM 79.

The access to the RAM 79 that the LCD controller 709 requests to the DMA controller 707 aims at reading data stored in the RAM 79 as display data to be displayed in the display unit 22. Therefore, the DMA signal generating unit 901 requests data reading from the RAM 79 to the DMA controller 707 at a certain time point on a regular basis. The DMA controller 707 that received the request reads the data from the RAM 79, and returns an acknowledgement signal DACK to the DMA signal generating unit 901 when the reading is finished, and sends the read data to the DMA signal generating unit 901.

The data read from the RAM 79 based on the request of the DMA signal generating unit 901 are input to the expanding unit 906. Since the RAM 79 stores 32-bit data resulting from compressing display data, the expanding unit 906 expands the compressed display data, and outputs the data to the output data generating unit 907 as display data for 2 screens (48-bit).

The output data generating unit 907 executes signal processing such as stripe-delta transform, gamma correction, or the like to the received 48-bit data, and transmits the decided data to the display unit 22 in the transmitting order. In addition, the output data generating unit 907 is provided with a synchronization signal generating unit 920 which generates various synchronization signals in order to operate the display unit 22. The composition of the synchronization signal generating unit 920 will be described later.

The SPI control unit 908 transmits a control command in the Serial Peripheral Interface (SPI) method to the display unit 22. The backlight control unit 909 controls the brightness of the screen by granting a control signal BL to the display unit 22, which instructs the duty of lighting the backlight (not shown) provided in the display unit 22. Since the composition and functions of the functioning blocks are well known, the description thereof will be omitted.

The setting register 910 holds a value of an internal register in order to decide an operation mode of the LCD controller 709. The setting register 910 is input with a register setting signal from the DMA signal generating unit 901. As described below, a part of a setting value of the setting register 910 is set based on a register setting signal given from the DMA signal generating unit 901.

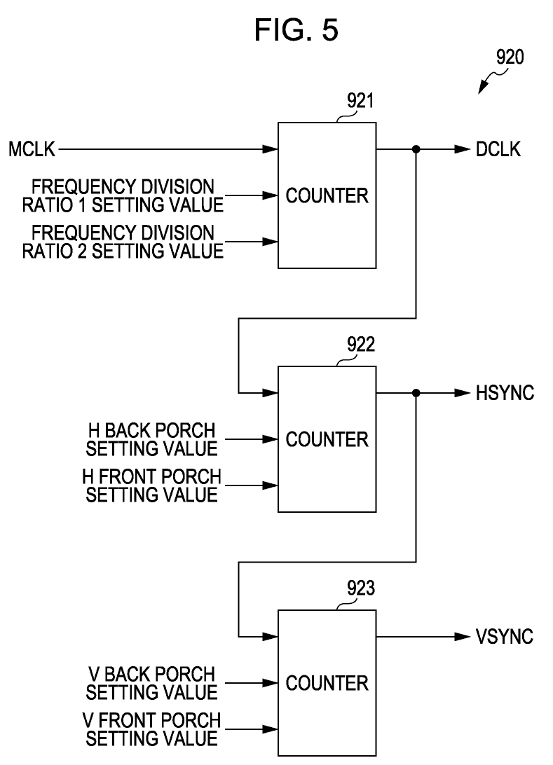

FIG. 5 is a block diagram illustrating the composition of the synchronization signal generating unit. The synchronization signal generating unit 920 is provided with three counters 921, 922, and 923, which are programmable counters. The first counter 921 is input with an original clock signal MCLK generated by an original clock generator (not shown). In addition, the first counter 921 outputs a clock signal obtained from the original clock signal MCLK subjected to frequency division at an appropriate frequency division ratio as a pixel clock signal DCLK that determines the transmission cycle of the display data sent out to the display unit 22. The frequency division ratio is determined by two setting values stored in the setting register 910, in other words, each of the setting values which are a frequency division ratio 1 and a frequency division ratio 2.

The pixel clock signal DCLK is input to the second counter 922. The second counter 922 generates and outputs a horizontal synchronization signal HSYNC by performing further frequency division on the pixel clock signal DCLK. More specifically, the horizontal synchronization signal HSYNC is output by giving a predetermined back porch and front porch that are determined by H back porch setting value and H front porch setting value set in the setting register 910 to the signal obtained by subjecting the pixel clock signal DCLK to frequency division at a predetermined frequency division ratio.

In the same manner, the third counter 923 performs frequency division on the horizontal synchronization signal HSYNC output from the second counter 922 and further outputs the signal given with predetermined back porch and front porch based on V back porch setting value and V front porch setting value set in the setting register 910 as a vertical synchronization signal VSYNC. The signals are transmitted to the display unit 22, which is an LCD display, and used to control display timing in the display unit 22.

Out of setting values stored in the setting register 910, the “frequency division ratio 1” and the “frequency division ratio 2” are set by register setting signals. The DMA signal generating unit 901 gives data for setting the “frequency division ratio 1” and the “frequency division ratio 2” to the setting register 910 as register setting signals based on command from the CPU 701. As such, the frequency division ratio 1 and the frequency division ratio 2 in the setting register 910 are set.

Accordingly, in the embodiment, a frequency division ratio when the pixel clock signal DCLK is generated from the original clock signal MCLK is determined according to the command from the CPU 701. In addition, since the pixel clock signal DCLK is constituted by original clock signals of the horizontal synchronization signal HSYNC and vertical synchronization signal VSYNC, the cycle of a timing signal sent to the display unit 22 can be changed by the setting values of the frequency division ratio 1 and the frequency division ratio 2. In other words, a frame rate of the display unit 22 can be changed for setting.

Next, a process for realizing the slide show function mentioned above will be described. The slide show function itself is a well known technique, and equipment and software that realize the function are already commercially-available. Hence, a well-known technique enables slide show operation when the print mechanism 50 does not carry out print operation. Thus, a process will be described mainly when the CPU 701 executes the slide show operation in parallel with the print operation by the print mechanism 50 hereinbelow.

The most significant problem in executing the print operation and the slide show operation in parallel is how to distribute the processing capability of the controller 70 for the two operations. Since it is necessary to frequently access to the RAM 79 in both of the operations, there are concerns that the two operations are in competition for the access to the RAM 79 and inconvenience may occur such as a delayed process for the operations. The operation to be described below can solve such concerns.

The slide show operation in the embodiment is one where three still images are switched to be displayed while an image of one page is formed, and during the switching of the still images, images for five screen pages, which are obtained by three-dimensional image processing of the still images before/after the switching, are switched in order and screen images with movement are displayed. By displaying such screen images to be used in switching, a visual effect can be obtained where it seems that the screen images gradually change, rather than being switched in an instant when the screen images displayed in the display unit 22 are switched from a first still image to a second still image. In other words, with the three-dimensional (3D) visual effect making it seem as if the pages of an album are being turned over, screen images can be displayed in the display unit 22 by successively switching from the first still image to the second still image. As for such still images, for example, photo images can be used which are stored in the memory card M. The photo images to be displayed in a slide show are read in advance from the memory card M and kept in the RAM 79.

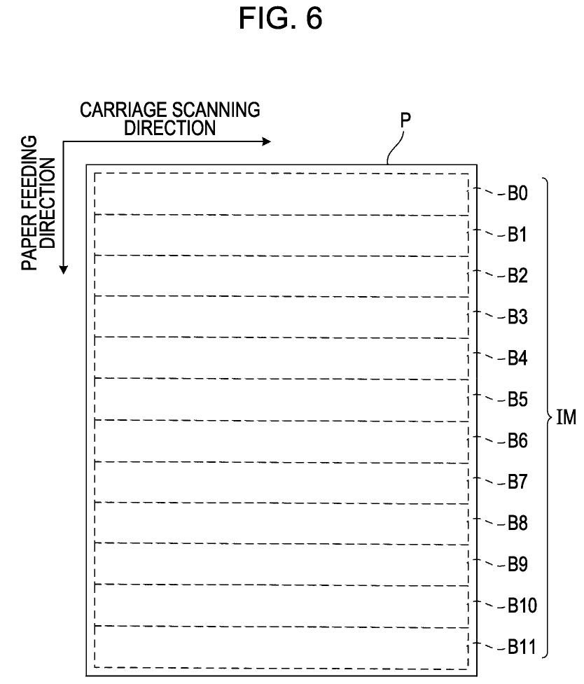

FIG. 6 is a diagram illustrating the structure of an image formed by the print mechanism. Print operation by the photo printer 10 is composed of a combination of an operation of forming a stripe-shaped image extending in a scanning direction by subjecting the carriage 53 to scanning movement and an operation of pitch-feeding the sheet P in a direction perpendicular to a carriage scanning direction. In other words, an image IM formed on the sheet P is one where stripe-shaped images B0 to B11, which are formed by one scanning movement of the carriage 53 and extend along the carriage scanning direction, are arranged in a paper feeding direction perpendicular to the carriage scanning direction without a gap. The example of FIG. 6 shows that 12 stripe-shaped images B0 to B11 form the image IM of one page.

Therefore, in the print operation, print data corresponding to the image IM are split into a plurality of block data (12 blocks) corresponding to each of the stripe-shaped images and sent to the print mechanism 50 from the controller 70. For this reason, a little spare time is generated from the end of output of one block data to the start of the output of the next block data. In this embodiment, by performing processing of the display data output in the display unit 22 during that time, the slide show operation can be performed while the print operation is performed.

However, time required for outputting the print data corresponding to each of the stripe-shaped images varies depending on the content of the stripe-shaped images, and thereby the spare time is not always regular. Hence, the CPU 701 analyzes the print data of one-page image to be formed prior to the start of the print operation, and arranges the schedule of the print operation and the slide show operation based on the analyzed result.

Herein, the operation resulting from the combination of one scanning movement of the carriage 53 and one paper feeding is referred to as a “pass”. That is to say, the image IM of one page is formed by 12 passes. The time required for executing one pass is a fixed value, for example, one second, but the time required for processing the print data varies depending on the data content.

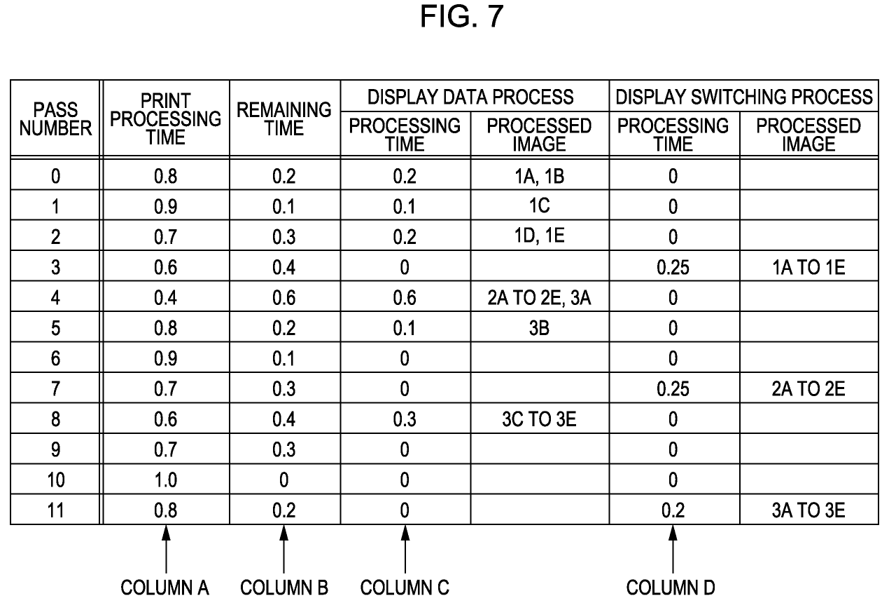

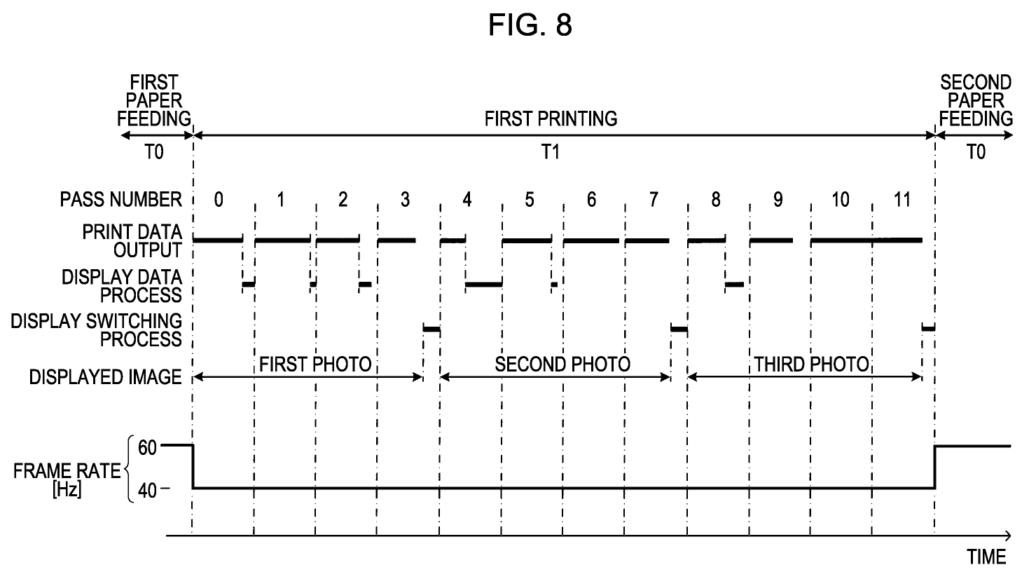

FIG. 7 is a diagram illustrating an example of a schedule table created as a result of scheduling. In addition, FIG. 8 is a timing chart illustrating processes based on the scheduling of FIG. 7. If the print data of one-page image are prepared, the amount of the print data for each pass can be learned, and thereby the time required for the output process can be predicted. As a result of analyzing the print data, the processing time for the print data predicted in 12 passes from the pass number 0 to 11, which are used for forming the image of one page, is each of the values shown in Column A of FIG. 7. At this point, the remaining time obtained by deducting the processing time for the print data from the time for executing each pass (1 second) is shown in Column B, and the remaining time can be appropriated to time for processing display data by the CPU 701 and the RAM 79, or the like.

In order to switch and display three still images during the execution of 12 passes corresponding to the image of one page, one switching of display images for every 4 passes is necessary. Thus, by using the remaining times of Pass 3, Pass 7, and Pass 11, switching of the display images (display switching process) is performed. Prior to the switching, data for switching and displaying need to be prepared. Scheduling is performed in advance in which a process for preparing the data (display data process) is assigned to the remaining time for other passes beforehand.

If it takes 0.1 seconds to process a one-screen image out of five-screen image constituting screen images for switching, 0.5 seconds are required for preparing five-screen display data. For example, in passes of pass no. 0, 1, and 2 (Passes 0, 1, and 2), the remaining time of Column B is respectively 0.2, 0.1, and 0.3 seconds, and therefore, a time of 0.6 seconds remains to Pass 3 in which display switching is performed. During the remaining time of each pass, 5-screen display data can be prepared by assigning display data processing of five times x 0.1 seconds. For example, data processing of Images 1A and 1B of first two screens out of five screens can be assigned to Pass 0, data process of Image 1C of third screen to Pass 1, data processing of Images 1D and 1E of fourth and fifth screens to Pass 2.

During that time, the display unit 22 is displayed with a first photo image (first still image) as a still image. In addition, in Pass 3, by displaying Images 1A to 1E created as above for every 0.05 seconds in order, the display image is switched from a first photo to a second photo (second still image). Accordingly, by creating an image composing a screen image for switching based on at least either of the first photo or the second photo, more preferably, both of the photos, the screen image to be displayed is smoothly switched from the first photo to the second photo.

The values in column C of FIG. 7 indicate execution time of a display data process, in which data for display switching are prepared, to be executed in each pass as a result of the scheduling. In addition, the values of column D indicate a process time for performing actual display switching by using data prepared as such.

In the same manner, data processing for Images 2A to 2E, which are used for display switching in Pass 7 and constitute screen images for switching when the second photo and the third photo are switched, can be assigned to Pass 4. Furthermore, data processing of Images 3A to 3E used in Pass 11 can be assigned to Passes 4, 5, and 8. Since the remaining time in Pass 11 (Column B) is 0.2 seconds, five screens in this display switching process can be displayed in 0.04 seconds each.

If each process is executed according to the scheduling prepared as above, a print data process for outputting print data to the print mechanism 50, a display data process for preparing data for display switching, and a display switching process that uses the prepared data are executed in a time-sharing manner. For this reason, each of the processes can be performed smoothly without having the process by the CPU 701 and access to the RAM 79 in competition between processes. In addition, since the burden of the CPU 701 and the RAM 79 can be reduced by scheduling to avoid competing processes beforehand, a high-performance processor or the like is not necessary, and thereby a small size and low cost of the apparatus can be attained.

In addition, the screen image displayed in the display unit 22 turns into a slide show in which three still images are switched while a one-page image is formed on one sheet P, and further, an outstanding visual effect in which the screen image during the switching is expressed by two gradually switching still images can be performed simultaneously.

It is not an essential requirement in the invention, but as shown in FIG. 8, in Term TO in which the sheet P is fed in the print mechanism 50 and Term Ti in which printing is performed onto the sheet, frame rates of the display unit 22 may differ. When data of images displayed in the display unit 22 are stored in the same RAM 79 as print data are, it is necessary to perform data transmission from the RAM 79 to the LDC controller 709 in a cycle corresponding to a frame rate on a regular basis, but there is a possibility that access to the RAM 79 may be in competition with output of the print data for the transmission. Therefore, such competition can be avoided by lowering the frame rate during the execution of print operation and reducing the frequency of access to the RAM 79. In other words, by changing the frame rate as such, the RAM 79 can take charge of storing display data without having an influence on print operation. Thereby, a dedicated device for storing display data can be omitted, and accordingly, a small size and low cost of the apparatus can be attained.

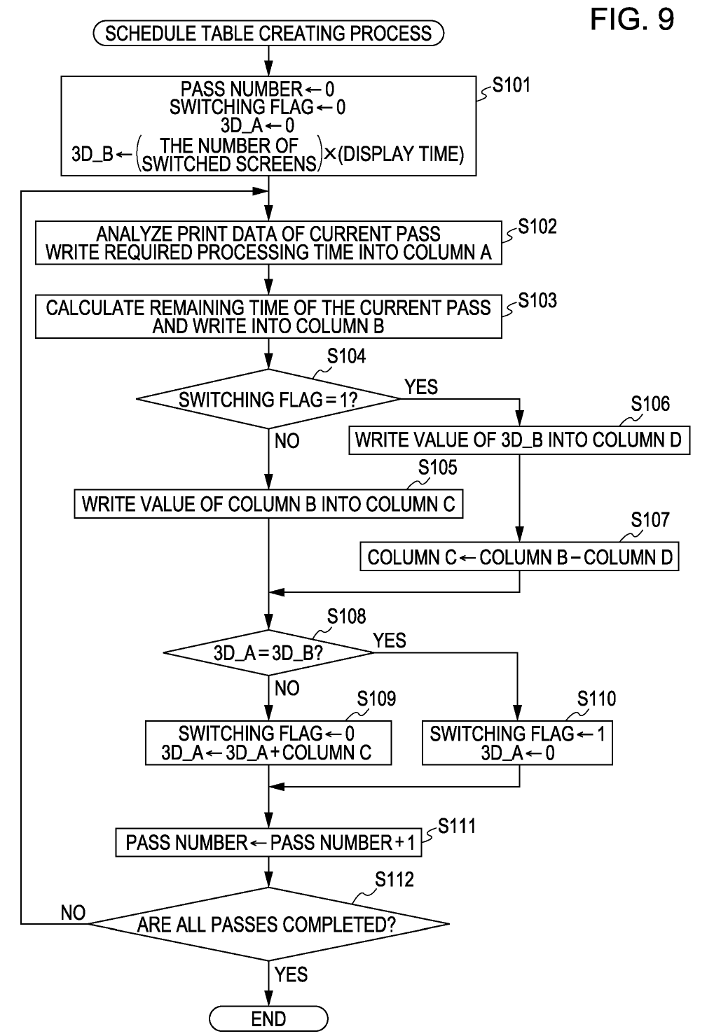

Next, a specific processing method for realizing the operation as above will be described below with reference to FIGS. 9 to 11. In this embodiment, scheduling of a process is performed by executing a schedule table creating process shown in FIG. 9 at a time when a process of creating print data of one-page image to be printed on the sheet P is ended, and based on the result, a print operation and display process (display data process and display switching process) are executed.

FIG. 9 is a flowchart showing the schedule table creating process of the embodiment. This process is performed by the CPU 701 and aims to create the schedule table exemplified in FIG. 7 on the RAM 79 or cache memory in the CPU 701. For the first, a pass number to be processed as an initial value, a switching flag for an internal process, and a internal parameter 3D_A are set to 0, and an internal parameter 3D_B is set based on the product of “the number of switched screens” indicating how many screens are used for display switching and “display time” maintaining display of each screen (Step S101). Here, the number of switched screens is 5 and the display time is 0.05 seconds. Accordingly, the value of the internal parameter 3D_B is 0.25, which indicates a processing time necessary for the display switching process.

Consecutively, in Step S102, a processing time of print data to be processed in the current pass expressed by a pass number is calculated by interpretation of the print data and written into Column A of the schedule table (FIG. 7) (Step S102). Next, the remaining time resulting from deduction of a print data processing time of Column A from the processing time corresponding to one pass (1 second) is obtained and written into Column B of the schedule table (Step S103).

Here, a switching flag is checked (Step S104). Since a setting value set at the initial stage is maintained at 0 (in other words, determination of “NO”), the process advances to Step S105 and the current value 0.2 of Column B is written into Column C. This indicates that 0.2 seconds out of the remaining time in the corresponding pass are decided to be assigned for the display data process. Then, two internal parameters 3D_A and 3D_B are compared with each other (Step S108). The internal parameter 3D_A indicates a value obtained by adding up completion time of the display data process, and the conditional expression of Step S108 is for determining whether assignment of an image (5 screens) process necessary for one display switching has been completed or not.

At this point, since only the assignment of the processing of two screens has been decided, the determination result is “NO”. Therefore, the process advances to Step S109, and a processing time for two screens decided for assignment to the internal parameter 3D_A, that is, the value of Column C is added while maintaining the switching flag as 0 (Step S109). In addition, the pass number increases by 1 (Step S111), and processes from Step S102 are repeated until processes for all passes are completed (Step S112). By repeating the loop process above, display data processing time is assigned for each pass in order until the assignment of the processing for 5 screens necessary for the switching process is determined as a whole (Step S108). When the assignment for 5 screens is ended (“YES” in Step S108), the switching flag is set to 1, and the internal parameter 3D_A is reset to 0 (Step S110).

As such, when the assignment of data processing for 5 screens necessary for the display switching is determined and the switching flag is set, Steps S106 and S107 are executed in the next loop by being branched from Step S104, and the value of the internal parameter 3D_B, that is, the processing time necessary for the display switching process is written into Column D of the schedule table, and on the other hand, a value obtained by deducting a value of Column D from a value of Column B (provided that the number is cut off to two decimal places) is written into Column C.

By repeating the process to Pass 11, a schedule table for the page is created. In addition, a print data output process is executed for each pass, and a display process is executed based on the schedule table subjected to scheduling.

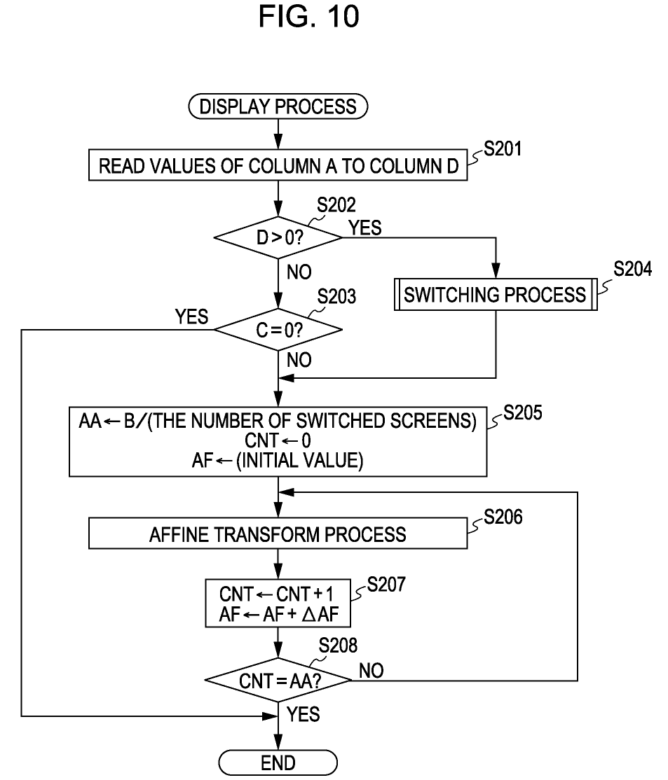

FIG. 10 is a flowchart showing the display process. The display process includes both of the “display data process” and the “display switching process” shown in FIGS. 7 and 8, and is executed by the CPU 701 successive to the print data output process for each pass. In the display process, first, values corresponding to passes written in Columns A to D are read out from the created schedule table (Step S201).

In addition, a value of Column D out of the values is checked (Step S202). If the value is greater than 0, the pass is a pass to be subjected to a display switching process, and therefore, a switching process (Step S204) to be described below is executed. On the other hand, if the value of Column D is equal to or smaller than 0, a value of Column C is successively checked (Step S203). If the value of Column C is not 0, a display data process for creating an image composing a screen image for switching to be displayed in the display unit 22 is executed. Prior to this, a value obtained by dividing a value of Column B by the number of switched screens (5 in this example) is stored as an internal parameter AA. In addition, an internal counter CNT is reset, and a parameter AF indicating a rotation angle of affine transform to be described below is set to an initial value (36 degrees in this example) (Step S205).

Consecutively, as a display data process, a process for converting a still image into a three-dimensional image is executed (Step S206). As an example of the process here, the affine transform of 36 degrees for the image (first still image) currently displayed in the display unit 22 is to be executed, but the form of such a process is not limited thereto, but arbitrary. For example, processes such as a wipe process, fade process, overlay process, slide process, and the like, which are widely used in an image process of the type may be performed. The image subjected to the affine transform is superimposed on an image (second still image) to be displayed next, and image data corresponding to image 1A are created and stored in the RAM 79.

The process is repeated while a parameter AF of affine transform is added by ΔAF (36 degrees) until the value of the counter CNT becomes the parameter AA, in other words, the process for 5 screens is completed (Steps S207 and S208). By doing this, image data for display for 5 screens (1A to 1E) of which transformed angles differ by 36 degrees are created. In addition, when the pass is a pass to be subjected to a process for display switching, the following switching process is executed by using the thus created data (Step S204).

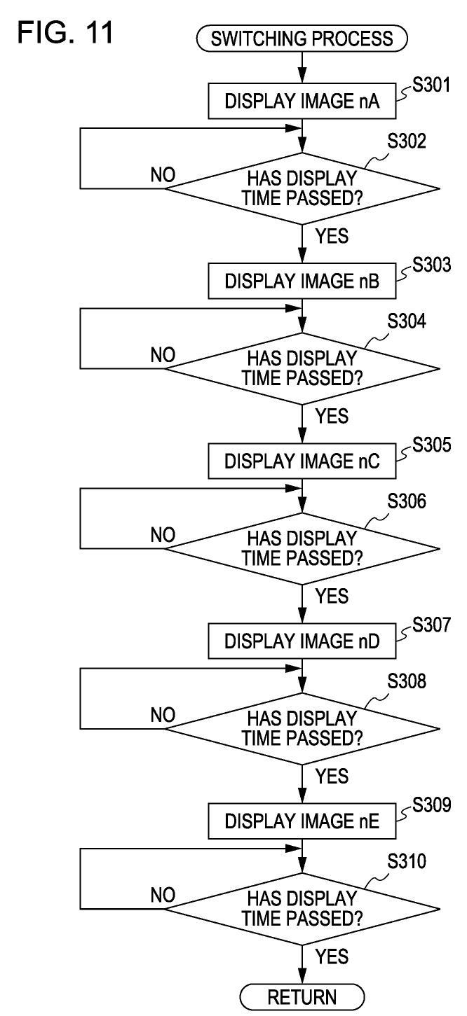

FIG. 11 is a flowchart showing the switching process of the embodiment. The switching process is a process for smoothly changing two still images. Since image data for 5 screens constituting screen images for switching have already been prepared here, the process is only for displaying the data in order. In other words, by transmitting display data corresponding to an image nA (n=1, 2, 3, . . . ) from the RAM 79 to the LCD controller 709, the image nA corresponding to the data can be displayed in the display unit 22 (Step S301). Then, passage of a predetermined display time (for example, 0.05 seconds) is awaited (Step S302), and the displayed image is switched to an image nB (Step S303). In the same manner, by displaying images nB, nC, nD, and nE in order in the display unit 22, display images can be switched accompanied by the expression of an excellent visual effect as in the first embodiment (Steps S304 to S310).

As shown in FIG. 8, when a frame rate is changed during the execution of print operation or before and after the operation, for example, a frame rate process as follows may be executed before the start of print operation and after the end of the operation.

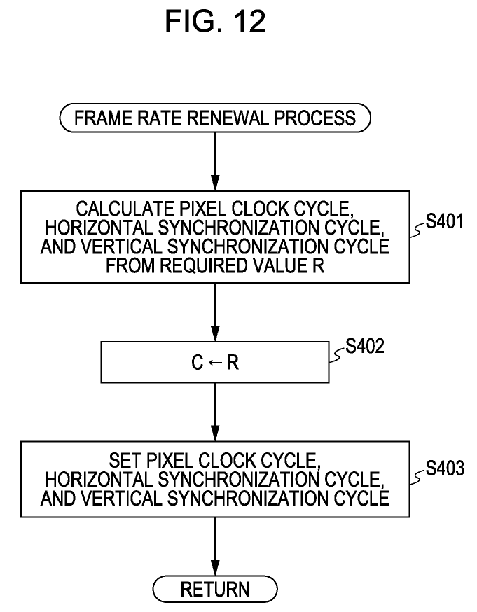

FIG. 12 is a flowchart showing a frame rate renewal process. This process is executed after a new frame rate required value (60 Hz or 40 Hz) R is determined when change in a frame rate is necessary. In this process, a pixel clock cycle, a horizontal synchronization cycle, a vertical synchronization cycle, or the like corresponding to the rate is calculated from the determined frame rate required value R (Step S401). In addition, a current frame rate setting value C is renewed by the required value R (Step S402). More specifically, parameter frequency division ratios 1 and 2 corresponding to the renewed frame rate setting value are written into RAM 79. In addition, the parameters are given to the LCD controller 709 via the DMA controller 707, written into the setting register 910 from the DMA signal generating unit 901, and the calculated pixel clock cycle, a horizontal synchronization cycle, a vertical synchronization cycle, or the like are renewed by a new setting value (Step S403). Accordingly, the frame rate is changed from 60 Hz to 40 Hz (before the start of printing) or from 40 Hz to 60 Hz (after the end of printing).

As above, in the embodiment, before print operation is started, the print data process and display data process are subjected to scheduling based on print data of one page, and print operation and display process are executed according to the result. By performing scheduling in advance as such, it is possible to exclude a possibility of competition between processes for print data and for display data beforehand, specifically, competition for access to the RAM 79 resulting from the processes.

For that reason, print operation by the print mechanism 50 and display operation by the display unit 22 can be executed in parallel without having an influence on each other. In other words, while printing is performed onto the sheet P by the print mechanism 50, a slide show can be displayed in the display unit 22 at the same time by switching a plurality of still images in order. In addition, by preventing the competition for access beforehand with prior scheduling, the RAM 79 can be shared between the data for display and data for printing, and a smaller size and lower cost of the apparatus can be achieved in comparison to a case where separate storage devices are provided therein.

More specifically, since transmission of print data for one page from the RAM 79 to the display unit 22 is executed by being divided into 12 passes, the remaining time in which transmission of print data is not being performed in the passes is assigned for a creating process of display data corresponding to screen images for display switching and for a display process of the data in the display unit 22. By doing this, slide show operation in which still images displayed in the display unit 22 are switched on a regular basis is realized, and further, the screen images for display switching prepared during the switching are displayed in the display unit 22. Therefore, a high level visual effect can be displayed in which screen images consecutively and smoothly change.

In addition, if a data transmission rate to the display unit 22, in other words, a frame rate when the print mechanism 50 executes print operation is lowered, access frequency to the RAM 79 reduces due to the data transmission, and therefore, competition for access to the RAM 79 can be reliably prevented.

As described above, in the embodiment, the print mechanism 50 and the display unit 22 respectively function as “an image formation section” and “a display section” in the invention. In addition, the print heads 55 in the print mechanism 50 function as “heads for printing”, and the transporting roller 56 functions as “a transporting mechanism” in the invention. Moreover, the CPU 701 and the RAM 79 in the controller 70 respectively function as “a control device” and “a storage section” in the invention. In addition, the paper feeding direction and the carriage scanning direction in the embodiment above each correspond to “the first direction” and “the second direction” in the invention. In addition, the sheet P in the embodiment above corresponds to “a recording material” in the invention.

The invention is not limited to the embodiment described above, and can be modified in various ways other than as above as long as the modification does not depart from the gist of the invention. For example, in the above embodiment, a processing time for one pass is fixed, but in the apparatus of that kind, a processing time for one pass combined with the time required for the output of print data and the time required for paper feeding may be changed dynamically. In such a case, scheduling can be arranged so that the display data process and display switching process are performed during the time obtained by deducting the time required for the output of print data from the time for processing one pass added with the time required for paper feeding.

In addition, in the embodiment, the frame rate for display in the display unit 22 is made to be switched in two stages of 60 Hz and 40 Hz, but the values of the frame rate are not limited to these values. However, when the visual capability of human beings is considered, a frame rate greater than 60 Hz is not necessary, and on the contrary, when the rate falls below 10 Hz, flickering is noticeable. Therefore, it is desirable to set a frame rate between these values. In addition, a frame rate can be changed in 3 stages or more.

In addition, in the above embodiment, print operation is performed by reading out image files stored in the memory card M, but the data format or the storage medium of the image files are not limited thereto, and various well-known formats or media can be used. For example, a storage medium having a magnetic disk or a storage medium in a disc shape may be used. Furthermore, the invention can be applied to equipment having a function of storing captured image files, such as a digital camera, a mobile phone, and the like, and for example, equipment reading image files through communication devices through a cable, wireless, infrared communication, and the like.

In addition, the print mechanism 50 in the above embodiment is an ink jet type printer, but for example, may be a digital photo type printer. Furthermore, the display unit 22 in the above embodiment is to display images through an LCD display, but may employ an electroluminescence (EL device) type display and the like for image display.

In addition, in the above embodiment, the invention is applied to a photo printer having a display function for displaying images corresponding to image files and a print function for printing the images, but the applicable object of the invention is not limited to the photo printer above. The invention can be applied to general equipment provided with a display function and a print function. Particularly, the invention is very effective in equipment aiming at achieving a small size and low cost.

What is claimed is:

1. An image forming apparatus comprising:
an image formation section that receives print data and forms an image corresponding to the print data on a recording material;
a display section that receives display data and displays a screen image corresponding to the display data;
a storage section that stores the print data and the display data; and
a control device that executes a print data process for outputting the print data from the storage section to the image formation section, and a display data process for creating the display data to write into the storage section and outputting the display data from the storage section to the display section;
wherein the control device performs scheduling for the print data process and the display data process based on the print data before output of the print data corresponding to an image of one page is started.

2. The image forming apparatus according to claim 1, wherein the control device outputs each piece of block data as block data, which are obtained by splitting the print data corresponding to the image of one page into a plurality of pieces, to the image formation section in order, and performs the scheduling according to a predicted result of time required for outputting each piece of the block data.

3. The image forming apparatus according to claim 2, wherein the control device outputs each piece of the block data in a predetermined cycle, and executes the display data process in a period different from a period for outputting the block data in one cycle.

4. The image forming apparatus according to claim 1, wherein the control device executes a slide show operation as the display data process in which a plurality of still images are switched and displayed in the display section in order.

5. The image forming apparatus according to claim 4, wherein, when the still images to be displayed in the display section are switched from a first still image to a second still image, the control device outputs display data for switching, which are created based on image data corresponding at least to one of the first still image and the second still image, to the display section.

6. The image forming apparatus according to claim 1, wherein the control device outputs the display data to the display section at a predetermined frame rate on a regular basis, and moreover, the frame rate is variable.

7. The image forming apparatus according to claim 1, wherein the image formation section includes a transporting mechanism that performs pitch-feeding of the recording material in a first direction and heads for printing that execute scanning movement in a second direction intersecting the first direction and supply a colorant on the recording material according to the print data, and forms an image on the recording material by alternately executing the pitch-feeding by the transporting mechanism and the scanning by the heads for printing.

8. An image formation method comprising:
executing a print data process in which print data stored in a storage section are given to an image formation section and an image corresponding to the print data is formed on a recording material, and a display data process in which display data stored in the storage section are given to a display section and a screen image corresponding to the display data is displayed; and
scheduling the print data process and the display data process based on the print data before the output of the print data corresponding to an image of one page is started.
